(19) United States
(12) Patent Application Publication
(10) Pub. No.: US 2025/0214219 A1
(43) Pub. Date: Jul. 3, 2025

(54) PAINT APPLICATOR CLEANING SYSTEMS AND METHODS

(71) Applicant: Robert L. Couch, Knoxville, TN (US)

(72) Inventor: Robert L. Couch, Knoxville, TN (US)

(21) Appl. No.: 19/086,892

(22) Filed: Mar. 21, 2025

Related U.S. Application Data
(63) Continuation-in-part of application No. 18/601,136, filed on Mar. 11, 2024, now abandoned.
(60) Provisional application No. 63/489,260, filed on Mar. 9, 2023.
(60) Provisional application No. 63/515,703, filed on Jul. 26, 2023.

(51) Int. Cl. B25F 3/00; A46B 17/06; B44D 3/00; B44D 3/08

(52) U.S. Cl. CPC B25F 3/00; A46B 17/06; B44D 3/006; B44D 3/08

(57) ABSTRACT

A system of cleaning a paint applicator, including a connecting member configured to connect a paint applicator to a spindle drive as an assembly, and a container configured to receive and enclose the assembly via an opening in the container to spin the assembly and remove and collect paint from the paint applicator, wherein the paint applicator can be either one of a paint roller or a paint brush.

### CROSS-REFERENCE TO RELATED APPLICATIONS

This application is a continuation-in-part of U.S. application Ser. No. 18/601,136, filed Mar. 11, 2024, which claims the benefit of U.S. Provisional Application No. 63/489,260, filed Mar. 9, 2023, and U.S. Provisional Application No. 63/515,703, filed Jul. 26, 2023; the contents of which are hereby incorporated by reference herein in their entirety.

### BACKGROUND OF THE INVENTION

### 1. Field of Invention

The present invention relates generally to devices and methods for cleaning painting applicators, and more particularly relates to systems, devices, and methods for cleaning paint applicators or instruments such as brushes and rollers, as well as for mixing paint and similar materials.

### 2. Description of the Related Art

The present general inventive concept relates generally to devices and methods for cleaning painting applicator instruments such as paint brushes and rollers. More particularly, the present general inventive concept relates to systems and methods of spinning paint applicators, i.e., implements, to efficiently remove paint therefrom. Paint rollers and brushes are well known in the art. However, existing devices and methods for cleaning paint brushes and rollers have been less than satisfactory, resulting in lost time, premature disposal, environmental damage, and other disadvantages.

U.S. Pat. No. 5,709,301 of the current inventor discloses storage devices for paint rollers, paint roller covers, and paint brushes. The storage devices for the paint rollers and paint roller covers are cylindrical containers, having a lid, which are flared outwardly at their upper portions and have a foam insert at the bottom for forming a spongy seal with the painting implement. The container for the cover has a core in it around which the roller cover fits. The lid, which can be a screw down or friction fit lid, among others, has a foam insert on its underside to form a spongy seal with the upper part of the roller cover. The container for the roller and the lid, which can be a friction fit lid, each have a semicircular opening lined with a gasket. The mating of the container and the lid result in the formation of a circular opening through which the handle of a roller frame can extend. The paint brush holder can be configured as a rectangular-shaped container having a foam insert fitted to its upper portion. The exterior of the insert can be sized to fit the container. The insert can have an opening for holding a paint brush collar to allow the bristles to be in the container without touching the bottom. The insert keeps the brush wet and from drying out. The insert can be replaced with an insert having the same exterior size, which will fit the container, and a different sized interior surface, to hold another size of paint brush.

### SUMMARY

Disclosed herein are various example embodiments of multiple present general inventive concepts. Example embodiments can relate generally to devices and methods for cleaning painting instruments, or paint applicators, such as brushes, rollers, pads, etc. In some embodiments, assemblies and methods of the present general inventive concept have applications for mixing paint, drywall, and similar materials.

Some embodiments provide a system of cleaning a paint applicator, including a connecting member configured to connect a paint applicator to a spindle drive as an assembly, and a container configured to receive and enclose the assembly via an opening in the container to spin the assembly and remove and collect paint from the paint applicator, wherein the paint applicator can be either one of a paint roller or a paint brush.

### BRIEF DESCRIPTION OF DRAWINGS

The above-mentioned and additional features of the invention will become more clearly understood from the following detailed description of the invention read together with the drawings in which:

FIG. 1 is an exploded perspective view of an assembly according to one example embodiment of the present general inventive concept, showing an example embodiment of a cleaning assembly comprising a roller frame or bracket and a connector shaft, together with a roller and a spindle drive;

FIG. 2 is a second perspective view of the example embodiment assembly shown in FIG. 1, showing a roller installed on the roller frame;

FIG. 3 is a perspective view showing the example embodiment assembly of FIGS. 1 and 2 proximate a container at least partially filled with water, with the roller about to be immersed in the water within the container;

FIG. 4 is a section view of the example embodiment shown in FIG. 3, showing the roller, the roller frame, and a portion of the extender shaft or spindle immersed in the water within the container;

FIG. 5 is a perspective view of the embodiment shown in FIGS. 1-4, showing how the roller frame and extender shaft can be inserted into an interior volume of the roller for purposes of storage and/or transport;

FIG. 6 is a section view of the example embodiment shown in FIG. 5, showing the roller frame and extender shaft positioned within the interior volume of the roller;

FIG. 7 is a perspective view of another example embodiment of the present general inventive concept, showing an assembly with a longer roller frame;

FIG. 8 is a perspective view of another example embodiment of the present general inventive concept, showing an assembly with a roller frame and extender shaft connector used with an electric screwdriver;

FIG. 9A is a perspective view of a paint brush handle including a connecting member having size configured to mount a brush handle to jaws of a spindle drive;

FIG. 9B is a perspective view of a paint brush handle including a shorter connecting member;

FIG. 9C is perspective view of a paint brush handle where the handle is shaped to be received by a mating connecting member for mounting a brush to a spindle drive;

FIG. 9D is perspective view of a paint brush handle where the handle is shaped to be received by a connecting member for mounting the brush to a spindle drive;

FIG. 10 is a perspective view showing the example embodiment assembly of FIG. 9A proximate a container at least partially filled with water, where the paint brush is about to be immersed in the container;

FIG. 11 is a perspective view showing the example embodiment assembly of FIG. 9A proximate a container at least partially filled with water, where the paint brush is immersed in the container;

FIG. 12 is a perspective view of an example embodiment of the present general inventive concept, showing a cleaning assembly having a roller frame or bracket, including a connecting or extender member having one end configured to securely mate with a spindle drive and the other end configured to securely mate with the roller bracket;

FIG. 13 is a perspective view of another example embodiment of the present general inventive concept, showing a cleaning assembly having a different shaped roller frame or bracket;

FIG. 14 illustrates an example brush/roller bracket member configured to hold either a paint roller or a brush handle, configured in accordance with an example embodiment of the present general inventive concept;

FIG. 15 illustrates a portable cleaning assembly container configured to receive a cleaning assembly via an opening of a cover thereof;

FIG. 16A illustrates a bracket member configured to receive a paint brush handle according to an example embodiment of the present general inventive concept;

FIG. 16B illustrates a bracket member configured to receive a paint roller according to an example embodiment of the present general inventive concept;

FIG. 17A illustrates a system where the paint brush can be spun at high RPM (e.g. about 1000 RPM or higher) inside a portable container filled with water or other cleaning agents, where the brush is held at a height above the bottom of the container by the movement mechanism to provide a slight gap between the ends of the bristles and the bottom of the container to enable water to surround the bristles;

FIG. 17B illustrates the system of FIG. 17A, where the brush is held at a height above the bottom of the container by the reciprocating movement mechanism to provide a slight compression between the ends of the bristles and the bottom of the container, to facilitate enhanced cleaning; and

FIGS. 18A and 18B illustrate a cleaning member adapted to scrape excess paint from the roller.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Generally, a roller spinning assembly includes a roller frame and a spindle connected to the roller frame. The roller frame is adapted to interact with a paint roller such that at least some portion of the roller fits over the roller frame. One end of the spindle is adapted to be received by a spindle drive such as the chuck of a drill. The spindle can be “locked” to the roller frame such that the spindle does not rotate independently of the roller frame. To clean the roller, the roller is fitted onto the roller frame, the spindle is fitted to the drill, and the roller, roller frame, and a portion of the spindle are immersed in water within a bucket. The drill spins the spindle, roller frame, and roller, and the spinning of the roller within the water acts to clean the roller quickly, removing paint and other extraneous material from the roller. The roller spinning assembly also has applications for mixing paint, as well as for mixing drywall mix and similar materials.

Thus, in some example embodiments of the present general inventive concept, a roller spinning assembly for cleaning a paint roller comprises a roller frame, and a spindle connected to the roller frame, said roller frame being adapted to interact with a paint roller such that at least some portion of the paint roller fits over the roller frame, and one end of the spindle being adapted to be received by a chuck of a drill, the spindle being locked to the roller frame such that the spindle does not rotate independently of the roller frame.

In further aspects of the present general inventive concept, a roller spinning assembly for cleaning a paint roller includes a roller frame and a spindle connected to the roller frame, the roller frame being adapted to interact with a paint roller such that at least some portion of the paint roller fits over the roller frame, and one end of the spindle being adapted to be received by a chuck of a drill, the spindle being connected to the roller frame in such a way that the spindle does not rotate independently of the roller frame.

In some embodiments, the roller frame includes a solid molded body including a central axial portion configured to fit with the spindle and a plurality of wings radiating from the central axial portion.

In some embodiments, the wings radiate from the central axial portion of the roller frame in a spiral configuration.

In some embodiments, the wings radiate from the central axial portion of the roller frame in a substantially orthogonal configuration.

In some embodiments of the present general inventive concept, a method of cleaning a paint roller includes providing a roller frame and a spindle connected to the roller frame, the roller frame is adapted to interact with a paint roller such that at least some portion of the roller fits over the roller frame, one end of the spindle being configured to be received by the chuck of a drill, and the spindle being connected to the roller frame such that the spindle does not rotate independently of the roller frame, fitting the roller is onto the roller frame, fitting the spindle is to the drill, immersing the roller, roller frame, and a portion of the spindle in water within a bucket, and spinning the spindle by activating the drill, whereby the spinning of the roller within the water acts to clean the roller quickly, removing paint and other extraneous material from the roller.

In some embodiments of the present general inventive concept, a method of cleaning a paint brush comprises connecting a paint brush with a handle to a spindle, one end of the spindle being configured to be received by the chuck of a drill, and the spindle being connected to the handle of the paint brush, fitting the spindle is to the drill, immersing the brush and a portion of the spindle in water within a bucket, and spinning the spindle by activating the drill, whereby the spinning of the brush within the water acts to clean the brush quickly, removing paint and other extraneous material from the brush.

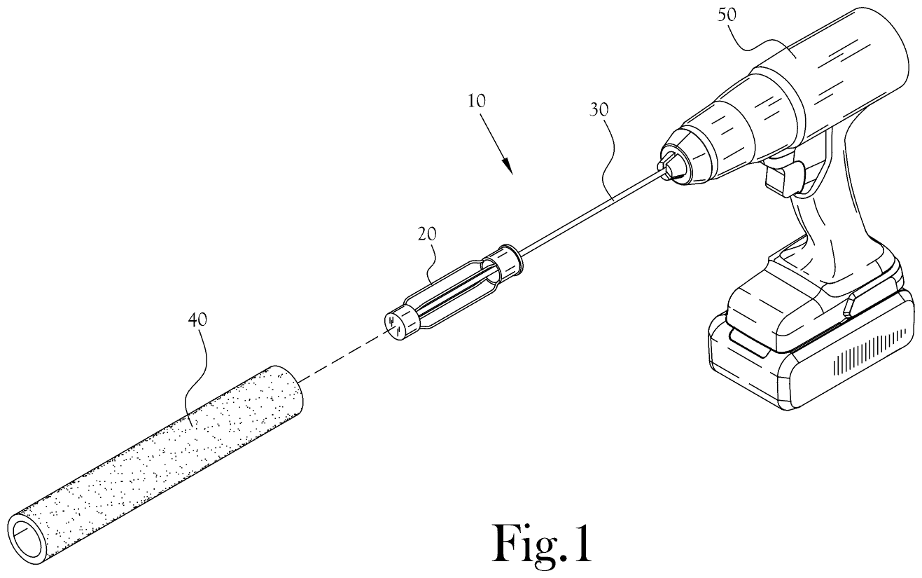

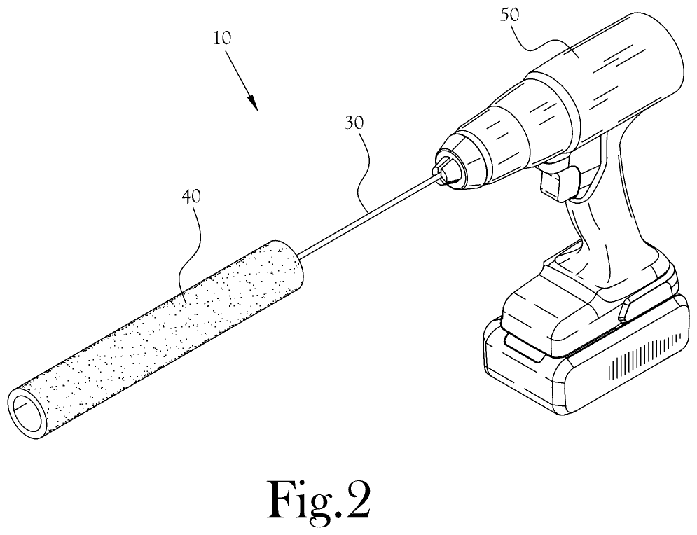

Turning to the Figures, FIG. 1 shows an exploded perspective view of an assembly according to one example embodiment of the present general inventive concept, illustrating an example embodiment of an assembly comprising a roller frame and an extender shaft, together with a roller and a drill. FIG. 2 is a second perspective view of the same example embodiment shown in FIG. 1, showing the roller installed on the roller frame. As shown in FIGS. 1 and 2, a roller spinning assembly 10 includes a roller frame 20 and a spindle, rod or extender shaft (hereinafter “spindle”) 30 connected to the roller frame 20. The roller frame 20 is adapted to interact with a paint roller 40 such that at least some portion of the roller 40 fits over the roller frame 20. One end of the spindle 30 is adapted to be received by the chuck of a drill 50. Generally, in embodiments of the present general inventive concept, the spindle 30 is affixed to the roller frame 20 such that the spindle does not rotate independently of the roller frame 20, and the roller frame 20 does not rotate on the spindle 30 (in contradistinction to many roller frames); that is, the spindle 30 is “locked” to the roller frame 20.

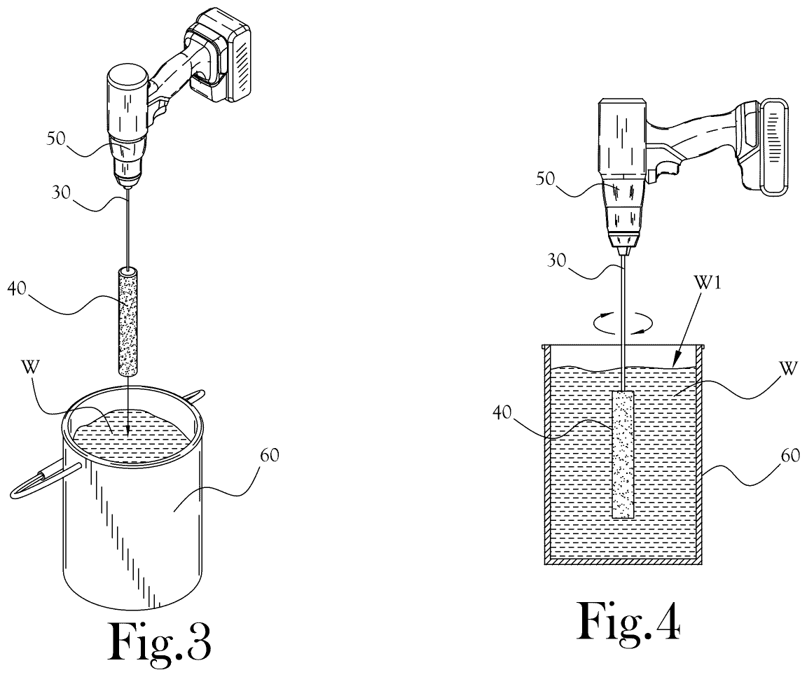

FIG. 3 is a perspective view showing the example embodiment assembly of FIGS. 1 and 2 proximate a bucket partially filled with water, with the roller about to be immersed in the water within the bucket. As shown in FIG. 3, when the roller 40 is to be cleaned, the roller 40 is fitted onto the roller frame 20 (as shown in FIG. 2), the spindle 30 is fitted to the drill 50, and the roller 40, roller frame 20, and a portion of the spindle 30 are immersed in the water W within the bucket 60. FIG. 4 illustrates in section view the roller 40, the roller frame 20, and a portion of the spindle 30 immersed in the water W within the bucket 60, with the entire roller 40 immersed beneath the surface W1 of the water W in the bucket 60. The drill 50 is then used to spin the spindle 30, roller frame 20, and roller 40, and the spinning of the roller 40 within the water W acts to clean the roller 40, removing paint and other extraneous material from the roller 40.

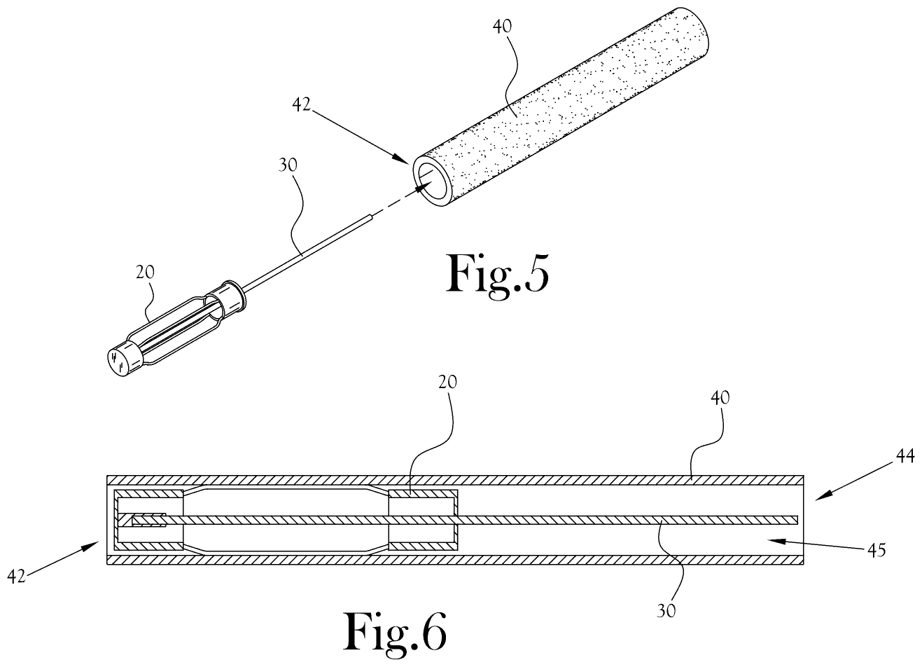

FIG. 5 is a perspective view of the embodiment shown in FIGS. 1-4, showing how the roller frame 20 and spindle 30 is inserted into an interior volume 45 of the roller 40 for purposes of storage and/or transport. Likewise, FIG. 6 is a section view of the example embodiment shown in FIG. 5, showing the roller frame 20 and spindle 30 positioned within the interior volume 45 of the roller 40. Generally, the roller frame 40 includes two open ends 42 and 44, and the roller frame 20 and spindle 30 are inserted into the roller 40 through one of the open ends.

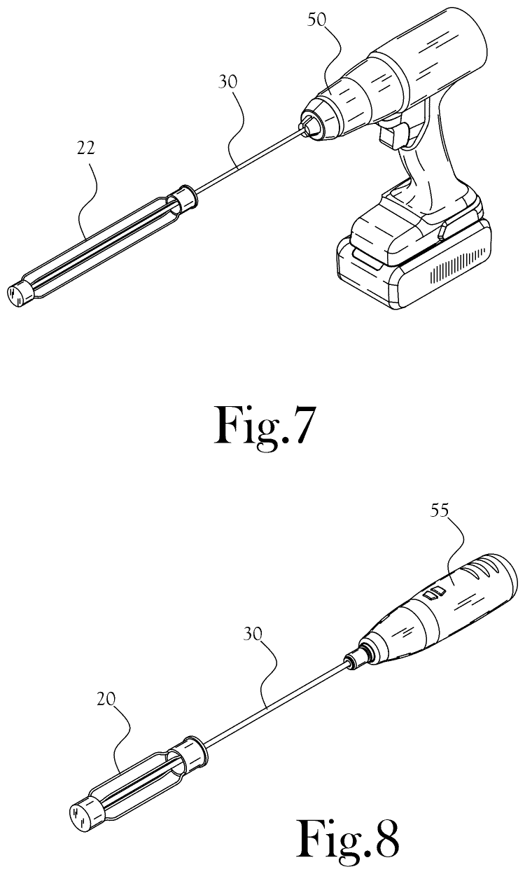

FIG. 7 is a perspective view of another example embodiment of the present general inventive concept, showing an assembly with a longer roller frame 22.

FIG. 8 is a perspective view of another example embodiment of the present general inventive concept, showing an assembly with a roller frame 20 and spindle 30 used with an electric screwdriver 55.

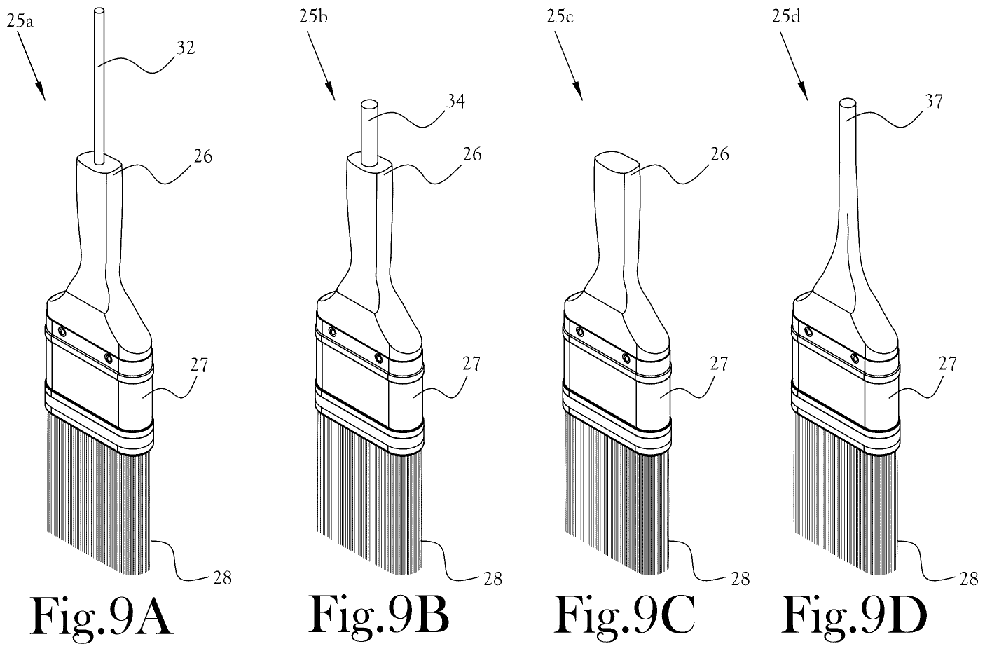

FIGS. 9A to 9D present perspective views of paint brushes configured to mount to a spindle drive. The brushes of FIGS. 9A and 9B include different length shafts 32, 34 to secure the brushes to a spindle drive aperture, whereas FIGS. 9C and 9D illustrate alternate exemplary handle configurations dimensioned and shaped to fit matingly to a connecting member of the spindle drive, but the invention is not limited to any particular mounting configuration. The example embodiment 25a shown in FIG. 9A can include a connecting member, such as extender shaft or spindle 32 that is notably longer than the extender shaft or spindle 34 of the in another example embodiment 25b shown in FIG. 9B. Otherwise, each paint brush can be adapted in shape and size to fit a connecting member to mount the brush as a cleaning assembly.

FIG. 9A is a perspective view of a paint brush handle including a connecting member having size configured to mount a brush to a spindle drive and FIG. 9B is a perspective view of a paint brush handle including a shorter connecting member.

FIG. 9C is perspective view of a paint brush handle where the handle can be shaped to be received by a mating connecting member for mounting a brush to a spindle drive.

FIG. 9D is perspective view of a paint brush handle where the handle can be shaped to be received by an alternately shaped connecting member for mounting the brush to a spindle drive.

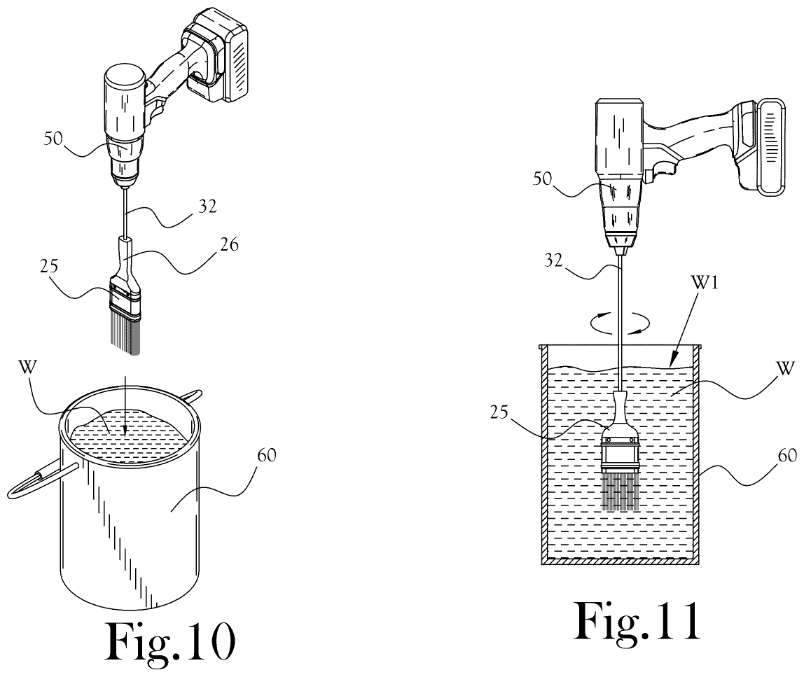

FIG. 10 is a perspective view showing the example embodiment assembly of FIG. 9A proximate a container at least partially filled with water, where the paint brush is about to be immersed in the container.

FIG. 11 is a perspective view showing the example embodiment assembly of FIG. 9A proximate a container at least partially filled with water, where the paint brush is immersed in the container.

As illustrated in FIGS. 10 and 11, the paint brush 25 is adapted to work within an assembly according to the present general inventive concept by having a spindle 32 attached to and extending from a distal end of the handle 26, as shown in FIG. 9A. That is, the spindle 32 extends from an end of the handle 26 that is opposite the end of the handle 26 where the handle 26 meets the ferrule 27. One end of the spindle 32 is adapted to be received by the chuck of a drill 50, as shown in FIG. 10. As further illustrated in FIG. 10, the adapted paint brush 25, connected by the spindle 32 to the drill 50, is positioned proximate a bucket 60 partially filled with water W, with the paint brush about to be immersed in the water W within the bucket 60. FIG. 11 is a section view of the example embodiment shown in FIG. 10, showing the paint brush and a portion of the extender shaft immersed in the water W within the bucket 60, with the entire paint brush 25 immersed beneath the surface W1 of the water W in the bucket 60. The drill 50 is then used to spin the spindle 32 and the paint brush 25 attached to the spindle 32, and the spinning of the paint brush 25 within the water W acts to clean the paint brush 25, removing paint and other extraneous material from the paint brush 25.

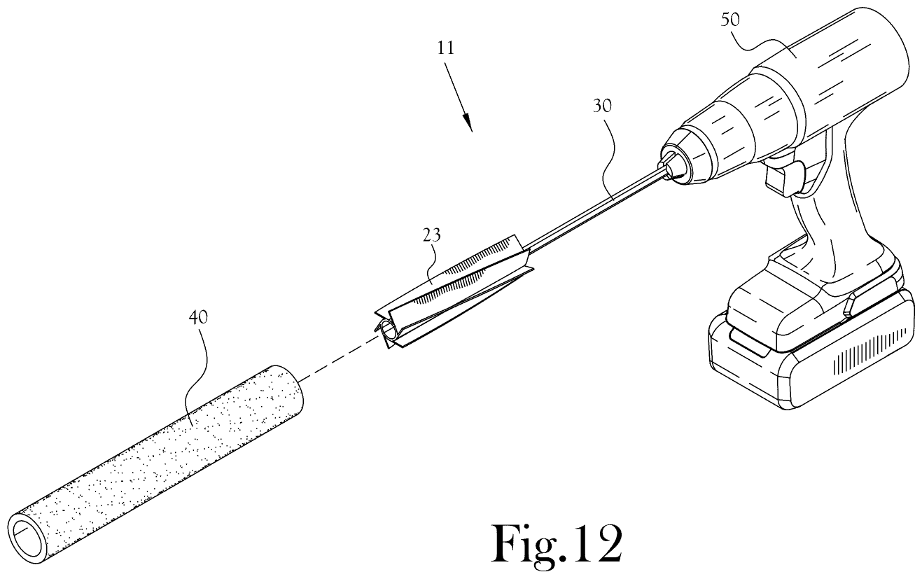

FIG. 12 is a perspective view of an example embodiment of the present general inventive concept, showing a cleaning assembly having a roller frame or bracket, including a connecting or extender member having one end configured to securely mate with a spindle drive and the other end configured to securely mate with the roller bracket.

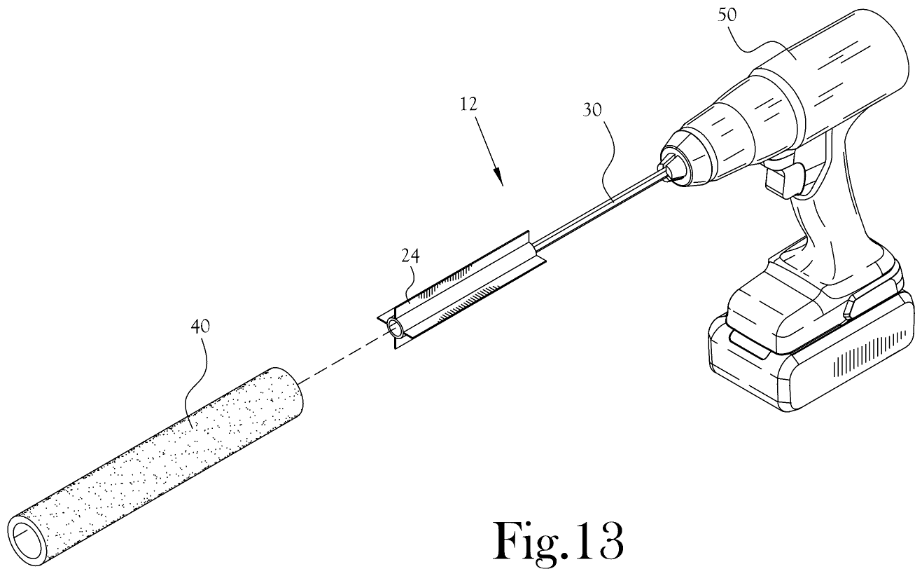

FIG. 13 is a perspective view of another example embodiment of the present general inventive concept, showing a cleaning assembly having a different shaped roller frame or bracket.

FIG. 12 and FIG. 13 show further example embodiments of the present general inventive concept, showing an assembly with a roller frame and extender shaft used with an electric screwdriver, wherein the roller frame comprises a solid molded body with a central axial portion configured to fit on or with the extender shaft and with a plurality of wings radiating from the central axial portion. FIG. 12 shows an embodiment 11 in which the wings radiate from the central axial portion of the roller frame 23 in a spiral configuration, while FIG. 13 shows an embodiment 12 in which the wings radiate from the central axial portion of the roller frame 24 in a substantially orthogonal configuration. Obvious modifications and variations will be apparent to those of skill in the art and are also encompassed by the present general inventive concept. In various embodiments, the roller frame solid molded body is fabricated from a hard plastic or from a similar material or from a material exhibiting similar physical properties.

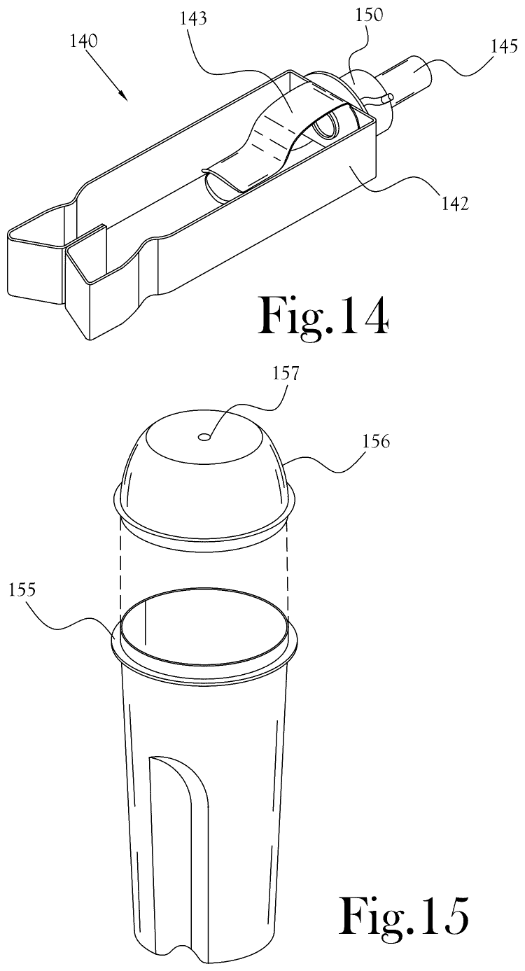

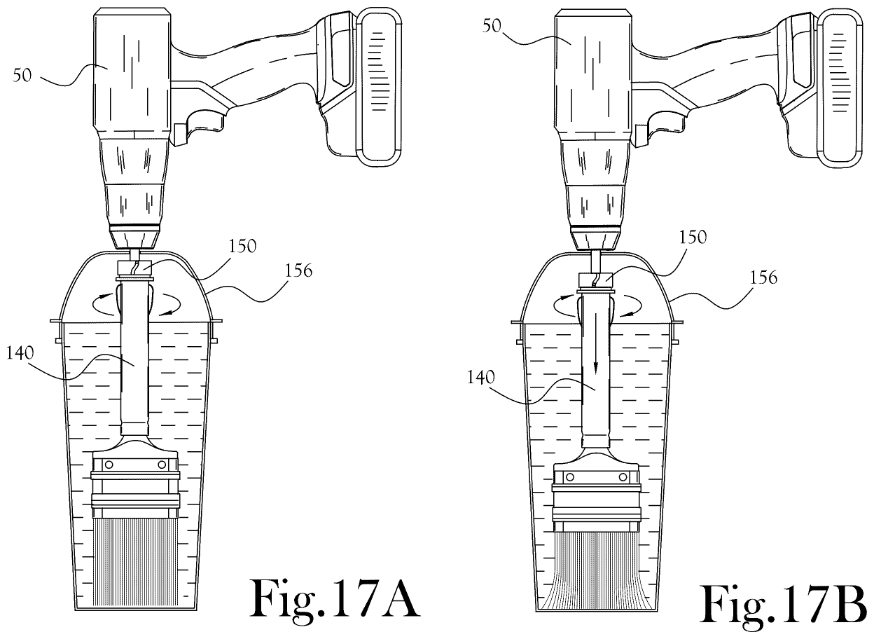

FIG. 14 illustrates an example brush/roller connector member, which in this example shows a bracket member 140, configured in accordance with an example embodiment of the present general inventive concept. In this connector embodiment, the bracket member 140 includes an outer cage 142 configured to receive the inside diameter of a paint roller, and an inner compression member 143 configured to receive the handle of a paint brush, depending on the shape and size of the particular brush handle. The example includes an optional reciprocating movement mechanism 150 configured to facilitate oscillating or reciprocal movement along a longitudinal axis of the spindle drive. The movement mechanism 145 can be configured in accordance with a connector member designed using sound engineering judgement, for example implementing a reciprocating cam member to provide longitudinal movement, and also to facilitate quick-change installation of the cleaning assembly to a spindle drive. In some embodiments, the connecting member 140 can be configured to receive either a paint brush handle or a paint roller to a spindle motor. The connecting member can be configured with a first end detachably mountable to a spindle drive and a second end configured with an opening to receive the handle of a paint brush to securely facilitate spinning movement of the applicator implement and removal of paint therefrom. An optional reciprocating movement mechanism can be configured to operate and cooperate with the bracket member to facilitate spinning of the cleaning assembly and reciprocal longitudinal motion within an enclosure container as illustrated in FIGS. 17A and 17B, for example a cam drive or other known or later developed mechanisms based on sound engineering judgement to accomplish reciprocal motion for enhance cleaning.

FIG. 15 illustrates a portable container enclosure configured to receive a cleaning assembly which is configured to receive either an attached paint roller or brush. The container is configured to function as a receptacle, including a top portion 156 and a bottom portion 155, wherein a hole or opening 157 can be configured to receive the spindle apparatus, as illustrated in FIGS. 17A and 17B.

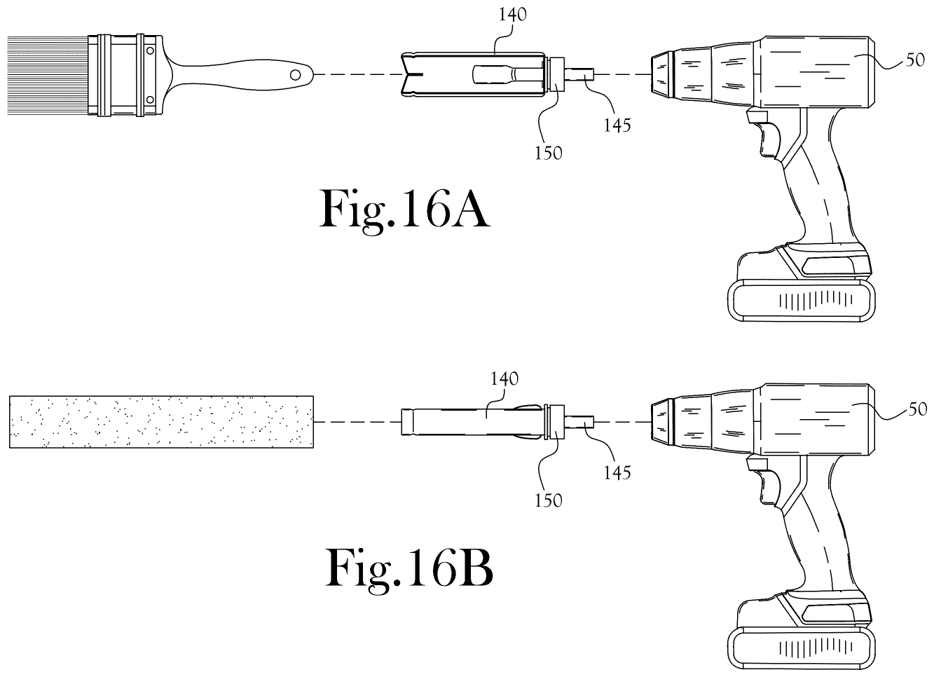

FIG. 16A illustrates a bracket member 140 configured to receive a paint brush handle according to an example embodiment of the present general inventive concept.

FIG. 16B illustrates a bracket member 140 configured to receive a paint roller according to an example embodiment of the present general inventive concept. It is also possible to mount a brush handle directly to the spindle drive using a connecting member similar to bracket 140 without the outer cage, wherein the connecting member optionally includes a movement mechanism to generate reciprocating movement of the brush or roller along a longitudinal axis of the spindle drive.

FIG. 17A illustrates a system where the paint brush can be spun at high RPM (e.g. around 1000 RPM or higher) inside a portable container filled with water or other cleaning agents, and where the brush can be held at a height above the bottom of the container by the movement mechanism to provide a slight gap between the ends of the bristles and the bottom of the container to allow water to surround the bristles.

FIG. 17B illustrates a system where the paint brush can be spun at high RPM (e.g. about 1000 RPM or higher) inside a portable container filled with water or other cleaning agents, and where the brush is held at a height above the bottom of the container by the reciprocating movement mechanism to provide a compression between the ends of the bristles and the bottom of the container, to facilitate swerving of the brushes against the bottom of the container for enhanced cleaning.

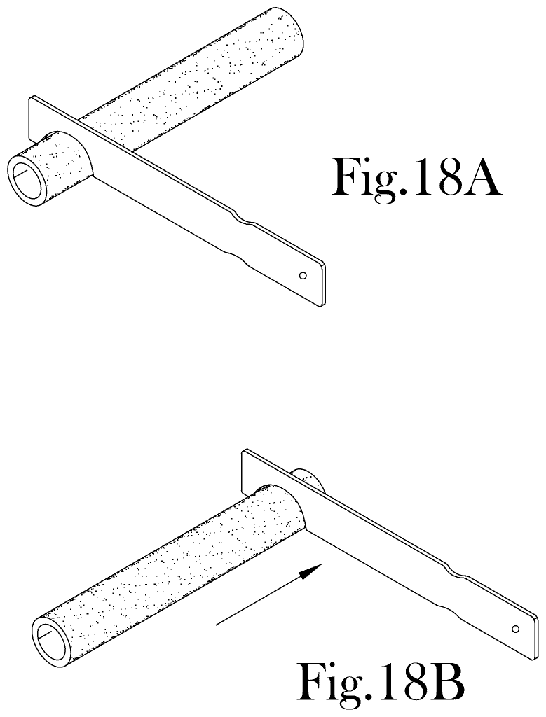

FIGS. 18A and 18B illustrate a cleaning member adapted to scrape excess paint from the roller before spinning.

As illustrated in the aforementioned figures, example embodiments of the present general inventive concept can be achieved by a system and method of cleaning painting implements where the system can be configured to provide spinning movement at high RPM of a painting implement wherein centrifugal forces within a container can assist the removal and collection of paint from a paint applicator, including a connecting member configured to quickly attach, detach, and reuse painting applicators. Some embodiments can include a reciprocating longitudinal movement mechanism configured to facilitate both spinning and longitudinal movement of the assembly for efficient, portable cleaning, collection, and/or disposal of the paint or other product from the applicator.

In some embodiments, the connecting member can be provided together with one or more of a bracket member configured to hold paint rollers and a compression member configured to receive brush handles, or other structures designed using sound engineering judgment to mate with the connecting member using sound engineering judgement.

Objects of the present general inventive concept create a high rpm (e.g., about 1,000 RPM or greater) cleaning device capable of quick-change and cleaning of painting applicators, portably, to efficiently extend the useful life and quality of paint applicators using less time, parts, and resources of known cleaning systems. Embodiments of the invention can reduce waste as users do not have to throw as many implements away, in favor of quick restoration and portable use and disposal of cleaning agents including water.

Various example embodiments of the present general inventive concept provide a paint roller cleaner that passes through and is configured to be stored within the roller, thereby making the paint roller cleaner and the roller easy to ship and/or sell as a combination, as well as occupying less space to display in-store. The spindle portion is locked to the roller frame. With assemblies according to the present general inventive concept, it takes only a minute (approximately) to clean a dirty roller in ten inches of water within a five-gallon bucket. The roller emerges from the cleaning process ready for the next color of paint.

In various example embodiments, assemblies and methods according to the present general inventive concept also have applications for mixing paint, as well as for mixing drywall or similar materials.

Generally, a roller spinning assembly can include a spindle motor including connectors for connecting and securing a painting implement to a reciprocating movement and clamping mechanism configured to receive a holder member of the painting implement to be cleaned. For example, a roller frame and a spindle can be connected to a roller frame. The roller frame can be adapted to interact with a paint roller such that at least some portion of the roller fits over the roller frame. One end of a connecting mechanism can be configured to be detachably mounted to the spindle motor, such as a chuck of a drill, collets, or other attachment means. The spindle can be “locked” to a roller frame such that the spindle does not rotate independently of the roller frame. To clean the roller, the roller can be fitted onto the roller frame, a spindle can be fitted to a drill, where the roller, roller frame, and a portion of the spindle can be immersed in water within a bucket or other container. The drill spins the spindle, roller frame, and roller, and the spinning of the roller within the water acts to clean the roller quickly, removing paint and other extraneous material from the roller. The roller spinning assembly also has applications for mixing paint, as well as for mixing drywall mix and similar materials.

Thus, in some example embodiments of the present general inventive concept, a roller spinning assembly for cleaning a paint roller comprises a roller frame, and a spindle connected to the roller frame, said roller frame being adapted to interact with a paint roller such that at least some portion of the paint roller fits over the roller frame, and one end of the spindle being adapted to be received by a chuck of a drill, the spindle being locked to the roller frame such that the spindle does not rotate independently of the roller frame.

In further aspects of the present general inventive concept, a roller spinning assembly for cleaning a paint roller includes a roller frame and a spindle connected to the roller frame, the roller frame being adapted to interact with a paint roller such that at least some portion of the paint roller fits over the roller frame, and one end of the spindle being adapted to be received by a chuck of a drill, the spindle being connected to the roller frame in such a way that the spindle does not rotate independently of the roller frame.

In some embodiments, the roller frame includes a solid molded body including a central axial portion configured to fit with the spindle and a plurality of wings radiating from the central axial portion.

In some embodiments, the wings radiate from the central axial portion of the roller frame in a spiral configuration.

In some embodiments, the wings radiate from the central axial portion of the roller frame in a substantially orthogonal configuration.

In some embodiments of the present general inventive concept, a method of cleaning a paint roller includes providing a roller frame and a spindle connected to the roller frame, the roller frame is adapted to interact with a paint roller such that at least some portion of the roller fits over the roller frame, one end of the spindle being configured to be received by the chuck of a drill, and the spindle being connected to the roller frame such that the spindle does not rotate independently of the roller frame, fitting the roller is onto the roller frame, fitting the spindle is to the drill, immersing the roller, roller frame, and a portion of the spindle in water within a bucket, and spinning the spindle by activating the drill, whereby the spinning of the roller within the water acts to clean the roller quickly, removing paint and other extraneous material from the roller.

In some embodiments of the present general inventive concept, a method of cleaning a paint brush comprises connecting a paint brush with a handle to a spindle, one end of the spindle being configured to be received by the chuck of a drill, and the spindle being connected to the handle of the paint brush, fitting the spindle is to the drill, immersing the brush and a portion of the spindle in water within a bucket, and spinning the spindle by activating the drill, whereby the spinning of the brush within the water acts to clean the brush quickly, removing paint and other extraneous material from the brush.

Some embodiments of the present general inventive concept can be achieved with reference to additional figures of this application.

The foregoing description of preferred embodiments of the present disclosure has been presented for purposes of illustration and description. The described preferred embodiments are not intended to be exhaustive or to limit the scope of the disclosure to the precise forms disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

In various example embodiments, assemblies and methods according to the present general inventive concept also have applications for use with painting instruments other than or beyond rollers.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A system of cleaning a paint applicator, comprising:
a connecting member configured to connect a paint applicator to a spindle drive as an assembly; and
a container configured to receive and enclose the assembly via an opening in the container;
wherein the paint applicator is a paint roller or a paint brush; and
wherein the connecting member includes an outer cage configured to receive an inside diameter of the paint roller and an inner compression member configured to receive a handle of the paint brush.

2. The system of claim 1, further comprising a reciprocating movement mechanism configured to facilitate reciprocal movement of a paint brush-connector assembly such bristles of the paint brush reciprocally contact a bottom surface of the container to facilitate cleaning of the paint brush.

3. An assembly for cleaning a paint roller, comprising:
a roller frame; and
a connector member having a first end connectable to the roller frame and a second end connectable to a spindle drive,
wherein the roller frame is configured to interact with a paint roller such that at least some portion of the paint roller fits over the roller frame, the connector being lockable to the roller frame such that the spindle does not rotate independently of the roller frame.

4. The assembly of claim 3, wherein said roller frame includes a solid molded body including:
a central axial portion configured to fit with the spindle; and
a plurality of wings radiating from the central axial portion.

5. The assembly of claim 4, wherein the wings radiate from the central axial portion of the roller frame in a spiral configuration.

6. The assembly of claim 4 wherein the wings radiate from the central axial portion of the roller frame in a substantially orthogonal configuration.

7. The assembly of claim 3, further comprising a container configured to portably enclose the connector member and the paint roller within water in the container such that when paint roller is rotated about an axis of the spindle drive, excess paint is removed from the paint roller and contained in the water of the container.
